(19) United States
(12) Patent Application Publication
(10) Pub. No.: US 2006/0172834 A1
(43) Pub. Date: Aug. 3, 2006

(54) Traction-means drive, method for detecting the wear of a continuous traction means and continuous traction means for such a traction-means drive

(76) Inventor: Jochen Laubender, Stuttgart (DE)

Correspondence Address: KENYON & KENYON LLP, ONE BROADWAY, NEW YORK, NY, 10004, US

(21) Appl. No.: 11/322,733

(22) Filed: Dec. 30, 2005

(30) Foreign Application Priority Data
Jan. 12, 2005 (DE) 10 2005 001 431.3

(51) Int. Cl. F16H 7/22; F16H 7/00; F16H 7/14; F16H 7/08

(52) U.S. Cl. 474/106; 474/87; 474/101; 474/117

(57) ABSTRACT

A traction-unit drive includes a continuous traction unit, e.g., a belt, which connects at least two belt pulleys connected to a drive element and a driven element. The traction-unit drive further includes an acoustic sampling device for sampling the surface of the continuous traction unit.

### FIELD OF THE INVENTION

The present invention relates to a traction-means drive and a method for detecting the wear of a continuous traction means of such a traction-means drive.

### BACKGROUND INFORMATION

In today's internal combustion engines, as well as in other drive systems, traction-means drives are now very frequently used. In this context, V-belt drives having V-belts made of plastic, rubber or similar materials are used for the transmission of power from the crankshaft to the camshaft, for example, or from a main shaft to an auxiliary shaft, in order to drive, e.g., a charger, a compressor or the like. The drive belts are subject to a high degree of wear and must therefore be replaced at regular maintenance intervals. In most cases, the wear pattern shows itself in a change of the elasticity of the drive belt, the formation or hairline cracks, an abrasion of the teeth in the case of toothed belts or in the loss of individual teeth and partly also in a change in thickness. Neglecting to adhere to the maintenance intervals can result in considerable malfunctions. Thus, when the valve operating mechanism in an internal combustion engine is controlled by a toothed belt, for example, a rupture of the toothed belt can result in the pistons striking the valves, thereby destroying the engine. As a consequence, a replacement of the engine is required, or at least complex and thus also expensive repairs.

Therefore, there exists the need to monitor the current state of a continuous traction means, e.g., of a V-belt or a toothed belt, with respect to its reaching the wear limit in order to prevent such damage.

A traction-means drive of this type is described in published German patent document DE 102 16 354, in which all components or components parts of the traction-means drive have an electrical conductivity irrespective of the material used. By determining the electrical conductivity, this makes it possible to continuously determine the state of wear of the traction means while the internal combustion engine is running. Since the resistance value of the traction means changes over its service life (in comparison to the resistance value at new condition), it is possible to replace the continuous traction means before it fails, by establishing a boundary value. For detecting the resistance value, sliding contacts that increase the friction, or complex contactless measuring devices that act inductively, are required in this context. In this context, it is problematic that, for example, contamination of the surface can change the resistance value, which can result in faulty conclusions regarding the wear.

A method for detecting the wear of a continuous traction means by using an optical scanner represents an improvement over the method utilizing the detection of the resistance value, as described in the published German patent document DE 102 16 354. In many cases, however, optical scanning is not possible. In particular, this optical scanning may also be disturbed if there are substances between transmitter and receiver that are impervious to light beams or that strongly attenuate light beams.

An object of the present invention is to provide an improved traction-means drive, as well as a method for detecting the wear of a traction means of such a traction-means drive, so as to make it possible to implement a contactless monitoring of the traction-means drive that is as independent of external influences as possible, and particularly enable a monitoring of the wear of the continuous traction means.

Another object of the present invention is to provide an improved continuous traction means that may be implemented for use in the above-mentioned improved traction-means drive.

### SUMMARY OF THE INVENTION

In accordance with the present invention, the traction means is acoustically sampled using a sound signal at standstill, or permanently during operation, or only at specific time or angle intervals, and to infer the state of the continuous traction means, e.g., of a V-rib belt or toothed belt, on the basis of the sampled signal detected in this manner.

For this purpose, stored reference signals of an unworn traction means may be compared with the sampled signal, and from this comparison the current state of the traction means, that is, of the drive belt, which is a toothed belt for example, is inferred. If a specified criterion is exceeded, then the replacement of the traction means is signaled to prevent damage to the engine in which the traction-means drive is used, for example, an internal combustion engine.

For this purpose, the sampling may be performed by a transmitting device for sending the sound signal and by at least one receiving device for receiving the sound signal reflected on the traction means.

The sound signal may be sent permanently by the transmitting device. One example embodiment provides for the transmitting device to send the sound signal in a pulsed manner.

The pulsed transmission may be synchronized with the rotational speed of the drive element.

For this purpose, the traction means has at least one coated surface that reflects sound signals.

To improve the sampling of the traction means further, one advantageous example embodiment provides for a tensioning device situated opposite from the sampling device in such a way that in the area of the sampling device, the traction means is redirected by a tension roller in such a way that the coated side of the traction means is facing the sampling device. Possibly existing cracks are expanded by the tension roller to a particularly high degree, allowing for an improved sampling of the surface. The redirection via a tension roller occurs particularly on the side of the toothed belt or V-rib belt facing away from the teeth or V-ribs.

The received sound signals are processed and evaluated in a circuit device that is advantageously part of an existing engine control unit.

In the process, the sampled signal is compared to a stored sampled signal of an unworn traction means. The wear is inferred from this comparison if a specified wear threshold value is exceeded. In this case, the circuit device generates and emits an optical and/or acoustic wear signal such that for example the driver of a vehicle is alerted to an imminent failure of the traction means. Moreover, the wear signal may also be stored in a fault storage and may be read out, for example, during maintenance work so that the traction means is replaced before the traction-means drive experiences failures and this results, for example, in a significant defect of an internal combustion engine.

The continuous traction means used in such a traction-means drive, that is, for example a V-rib belt or toothed belt, has at least on at least one of its surfaces at least one layer that reflects sound signals particularly well. For example, this layer is situated on the V-rib or tooth side of the V-rib belt or toothed belt.

### BRIEF DESCRIPTION OF THE DRAWINGS

FIG. 1 shows a schematic illustration of the front view of an internal combustion engine having an acoustic sampling device for detecting the wear of a continuous traction means.

FIG. 2a shows a schematic representation of an acoustic sampling device for detecting the wear of the traction means and sampled signals according to a first exemplary embodiment of the present invention.

FIG. 2b shows a graph illustrating the sound intensity plotted against the frequency of a worn continuous traction means.

FIG. 2c shows a graph illustrating the sound intensity plotted against the frequency of a new, unworn traction means.

FIG. 3a shows a schematic representation of an acoustic sampling device for detecting the wear of the traction means and sampled signals according to a second exemplary embodiment and a third exemplary embodiment of the present invention.

FIG. 3b shows the sound intensity plotted against the frequency of a worn continuous traction means.

FIG. 3c shows the sound intensity plotted against the frequency of a new, unworn traction means.

### DETAILED DESCRIPTION

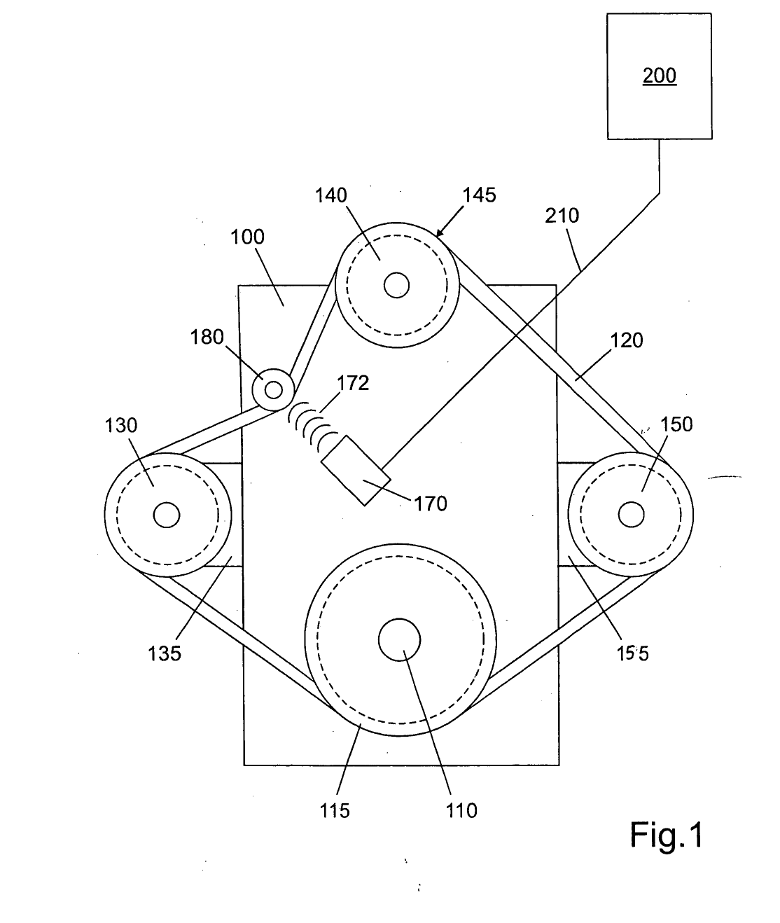

FIG. 1 schematically shows an engine 100, for example an internal combustion engine of a motor vehicle, the crankshaft 110 of which engine drives a belt pulley 115. Across the belt pulley 115 runs, for example, a V-rib belt 120, which additionally runs across belt pulleys 130, 140, 150 on the drive shafts, for example, of a water pump 135, a servo pump 145 and an alternator 155, respectively. A tensioning device is provided for tightening V-rib belt 120, which has a tension roller 180, across which V-rib belt 120 is laid and which exerts a tensional force on V-rib belt 120.

The entire assemblage made up of belt pulleys 115, 130, 140, 150 and tension roller 180 represents a traction-means drive, the traction means being formed by V-rib belt 120. In addition to V-rib belt 120, toothed belts are also often used as traction means, which like V-rib belt 120 also allow for a form-fitting traction means drive and thus also allow for driving a plurality of aggregates such as, for example, generators, ventilators, water pumps, air-conditioning compressors, power-steering pumps and the like.

An acoustic sampling device 170 is situated at the front side of engine 100 in the area of the traction-means drive, which emits a sound signal 172 and receives it again. The sampled signals are supplied via an electric signal line 210 to an evaluation electronics, for example, to a control unit 200, in which the sampled signals are evaluated in the manner described below.

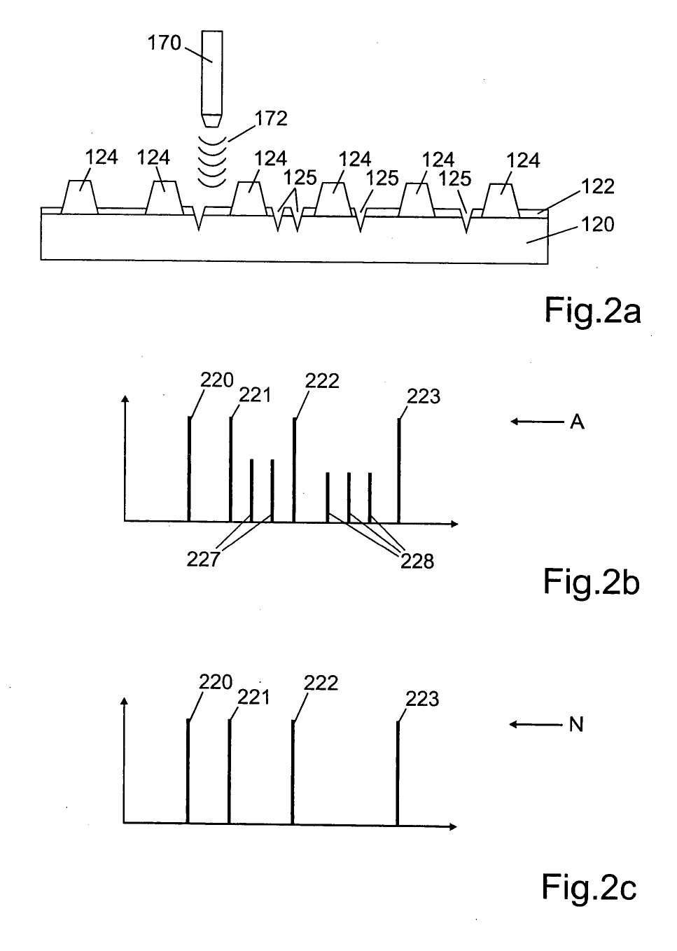

In accordance with the present invention, the V-rib drive belt 120 is now used, the bottom side of which is coated with at least one surface 122 that reflects sound signals particularly well, as shown in FIG. 2a. Sound signal 172 emitted by sampling device 170 is thus reflected on this coating 122 and is received by a sensor (not shown in FIG. 2a) situated in the sampling device.

An ultrasonic source or also an infrasonic source may be used as sound source. The reflected sound waves are detected or evaluated. For this purpose, the current state of wear of drive belt 120 is ascertained using an evaluation algorithm that is part of control unit 200 on the basis of propagation delay differences, intensity fluctuations or decreases in intensity, the excitation of harmonic oscillations, interference frequencies and the like. The evaluation is performed with the aid of an evaluation algorithm, a neural network, a fuzzy logic and the like. It should be pointed out that sampling device 170 may be situated at any location of the engine 100 along which drive belt 120 is running.

A new, unworn drive belt, which has no hairline cracks 125 (shown in FIG. 2a), produces a signal pattern shown in FIG. 2C and marked by “N” having a characteristic frequency pattern of the reflected sound waves. With increasing wear, i.e., if for example hairline cracks 125 (shown in FIG. 2a) between teeth 124 due to the strong flexing motions when drive belt 120 revolves over the different belt pulleys 115, 130, 140, 150 as well as over tension roller 180, this signal pattern changes in that, for example, the number of different peaks at different frequencies, the signal intensity and the like changes. Thus, in a new unworn drive belt 120, for example, signal N (shown in FIG. 2c) contains characteristic frequency peaks 220, 221, 222, 223. In the signal pattern A (FIG. 2b) of a worn V-belt that has a plurality of hairline cracks 125, interference frequencies 227, 228 are detected in addition to these frequency peaks 220, 221, 222 and 223. The state of wear of drive belt 120 is inferred from the changes in the frequency spectrum. Changes in the frequency spectrum that lead to an inference of a worn state of drive belt 120 may also include, in addition to the occurrence of interference frequencies 227, 228, the excitation of harmonic waves of a fundamental wave/frequency, and/or phase shifts between sent and reflected frequencies, and/or wavelength changes between sent and reflected frequencies, and/or propagation delay differences between sent and reflected frequencies. Pattern comparisons, signal level comparisons, frequency comparisons, rate of repetition comparisons, difference comparisons and the like can be used as comparison methods.

In the evaluation electronics, which is part of control unit 200 and which may be implemented, for example, as a program or take the form of a neural network, detected signal “A” of worn drive belt 120 is now compared to signal “N” of unworn drive belt 120, and from this comparison an inference is made to the wear of drive belt 120.

FIG. 2a schematically show the assemblage of sampling device 170 on the bottom side, that is, the “toothed side,” of a drive belt 120 that runs essentially uncurved. The sampling precision may be increased further by situating sampling device 170 opposite tension roller 180, which redirects drive belt 120 in such a way that its bottom side is facing sampling device 170 (FIG. 1). Tension roller 180 stretches the bottom side of drive belt 120 to a particularly high degree, which results in a widening of possibly present hairline cracks, which allows sampling device 170 to detect them better.

Following the comparison of signal pattern “N” of a new, unworn drive belt and signal pattern “A” of sampled drive belt 120, the wear is indicated, for example, by the fact that an acoustic or optical warning sign is issued, for example, to a driver of a vehicle in which the above-described traction-means drive is situated, thereby indicating that a specified wear threshold value has been reached. Furthermore, an error message may also be stored in a memory and be read out, e.g., during a later maintenance work.

The sampling may occur during a standstill of engine 100, occur continuously during engine operation, or only at certain time or angle intervals.

The sound signal 172 used may be permanent, pulsed or be switched on and off in synchronization with the rotational speed of crankshaft 110, for example.

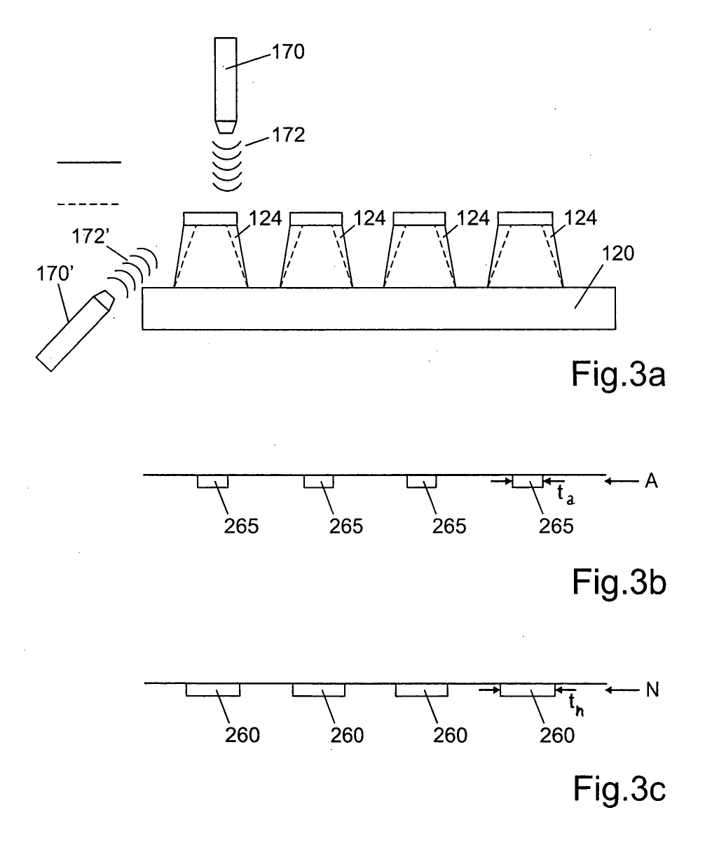

In an exemplary embodiment of the sampling implementation of a drive belt 120 and the signals obtained thereby shown in FIGS. 3a through 3c, identical elements are indicated by identical reference symbols as in the exemplary embodiment shown in FIGS. 2a-2c.

In contrast to the exemplary embodiment shown in FIGS. 2a through 2c, in the exemplary embodiment shown in FIG. 3a the upper side of teeth 124 is sampled. In addition to the upper side of teeth 124, it is also possible to additionally or alternatively sample their slopes. With increasing wear, the tooth/slope width decreases such that the sampled square-wave signal A (FIG. 3b) with increasing wear changes significantly in comparison to the signal N of a new, unworn drive belt 120 (FIG. 3c). Thus the width tₙ of the square-wave flange of signal N of an unworn, new drive belt 120 decreases with increasing wear in that the teeth are ground down, such that the width tₐ of square-wave pulses 265 of a worn drive belt 120 becomes smaller, as shown schematically in FIG. 3b illustrating the signal pattern A. This change is evaluated in control unit 200. In this case, the tooth time correlates with the rotational speed of the drive. Depending on the rotational speed, specific tooth times are produced which can be stored in a characteristics map or a value table or in a corresponding manner. With increasing wear, the tooth times become significantly shorter than the reference values at the same rotational speed. The differences of the tooth times may thus be used for the diagnosis.

If manufacturing-related tolerances of the tooth width cannot be avoided, averaged tooth times may also be used as a diagnostic signal.

In addition, a gap is created on drive belt 120 when a tooth falls out, for example, and as a consequence a pause in the sequence of the tooth times occurs, which is also detected.

FIG. 3a furthermore shows another, third exemplary embodiment having a sampling device 170′, which does not lie opposite of the bottom surface of the drive belt 120, but is situated in such a way that the sound strikes at an angle from below and is reflected, for example, on a slope of a tooth and is received in a receiving unit (not shown).

What is claimed is:

1. A traction-means drive, comprising:
a continuous traction unit;
a drive element;
at least two belt pulleys connected to the drive element and a driven element by the continuous traction unit, wherein the continuous traction unit is a belt; and
an acoustic sampling device for sampling a surface of the belt.

2. The traction-means drive as recited in claim 1, wherein the acoustic sampling device includes at least one transmitting device for transmitting a sound signal directed towards the belt and at least one receiving device for receiving the sound signal reflected from the belt.

3. The traction-means drive as recited in claim 2, wherein the sound signal is one of an ultrasonic and an infrasonic signal.

4. The traction-means drive as recited in claim 3, wherein the sound signal is continuously transmitted by the transmitting device.

5. The traction-means drive as recited in claim 3, wherein the sound signal is transmitted in a pulsed manner by the transmitting device.

6. The traction-means drive as recited in claim 5, wherein the pulsed transmission of the sound signal is synchronized with a rotational speed of the drive element.

7. The traction-means drive as recited in claim 3, wherein the belt has at least one surface that is coated with a sound-reflecting material to reflect sound signals.

8. The traction-means drive as recited in claim 7, further comprising:
a tensioning device situated opposite of the sampling device, wherein the tensioning device includes at least one tension roller which redirects the belt in such a way that the at least one surface coated with the sound-reflecting material faces the sampling device.

9. The traction-means drive as recited in claim 7, further comprising:
a control device operatively connected to the acoustic sampling device, wherein the control device processes and evaluates sound signals received from the acoustic sampling device.

10. A method for detecting a wear of a continuous traction unit of a traction-means drive, comprising:
coating at least one surface of the continuous traction unit;
acoustically sampling surface characteristics of the at least one surface of the continuous traction unit; and
determining the wear of the continuous traction unit based on sampled acoustic signals indicating the surface characteristics of the at least one surface.

11. The method as recited in claim 10, wherein the at least one surface of the continuous traction unit is coated with a sound-reflecting layer.

12. The method as recited in claim 11, wherein the sampling is performed continuously.

13. The method as recited in claim 11, wherein the sampling is performed periodically at specified time intervals.

14. The method as recited in claim 13, wherein the sampling is performed at specified time intervals synchronized with a rotational speed of one of: a) a drive element; b) a crankshaft of an internal combustion engine; and c) a camshaft of an internal combustion engine.

15. The method as recited in claim 11, wherein the sampled acoustic signals are compared with stored signals corresponding to an unworn continuous traction unit, and wherein the wear of the continuous traction unit is determined based on the comparison.

16. The method as recited in claim 11, further comprising:
if the wear of the continuous traction unit exceeds a specified wear threshold value, generating at least one of an optical wear signal and an acoustic wear signal.

17. The traction-means drive as recited in claim 6, wherein the belt has at least one surface that is coated with a sound-reflecting material to reflect sound signals.

18. The traction-means drive as recited in claim 17, wherein the belt is one of: a) a V-rib belt coated on a V-rib side with at least one sound-signal-reflecting layer; and b) and a tooth belt coated on a tooth side with at least one sound-signal-reflecting layer.
